(19) United States
(12) Patent Application Publication
(10) Pub. No.: US 2005/0241391 A1
(43) Pub. Date: Nov. 3, 2005

(54) Targeted guided wire level measuring device

(75) Inventor: Carl Kull, Banglamung (TH)

Correspondence Address: Jones, Walker, Waechter, Poitevent,;Carrere & Dengre, L.L.P., 4th Floor, 8555 United Plaza Boulevard, Baton Rouge, LA, 70809, US

(73) Assignee: K-Tek, L.L.C., Prairieville, LA (US)

(21) Appl. No.: 10/835,365

(22) Filed: Apr. 29, 2004

(51) Int. Cl. G01F 23/52

(52) U.S. Cl. 73/313; 73/290 V

(57) ABSTRACT

The invention is an improved guided wave level measurement device. A guided wave measuring device includes a waveguide, a signal generator and a signal receiver, where the signal generator and signal receiver are operationally connected to the waveguide. The improvement included a target which is displaceable with respect to the waveguide and coupled to the waveguide. The target presents a reflective surface and the position of the target is detectable through time of flight measurements of a signal generated by the signal generator.

### FIELD OF THE INVENTION

The present invention relates to a system and method for monitoring fluid levels in containers, such as storage tanks, and more particularly, to systems using guided wave level measurement devices.

### BACKGROUND OF THE INVENTION

Various devices have been conventionally employed to measure the level of a fluid or the interface levels between two mediums (such as air/water or oil/water). Generally, these devices consist of a sensor within a container, and means for sending data from the sensor to a remote location where it would be detected and converted into a usable format representative of the level of fluid within the container.

Mechanical and electromechanical sensors include floats and magnetostrictive devices. One means of level detection is through non-contact time of flight measurements, which generally have no sensor located at the fluid interface. In non-contact devices, a signal source or generator is used to emit a pulse of energy or signal in the tank, such as a radar pulse. In these systems, the free propagating signal is transmitted toward the fluid surface upon which it is reflected at the fluid interface due to a change in dielectric constant across the interface. The reflected signal is detected by a receiver, and the signal's time of flight is measured. Using this measurement, the distance between a reference point and the fluid level can be calculated. Some non-contact devices include utilized sonic or ultrasonic signals, microwave or radar signals, or other electromagnetic signals.

Most conventional non-contact devices provide accurate indications of fluid level and respond quickly to changes in the fluid levels if properly designed and adapted to the constraints of the system. For instance, sonic devices can be inaccurate if the propagating velocity is not compensated for temperature, pressure and humidity conditions along the propagation path of the signal. In very deep tanks, however, a free propagating signal can lose much energy through attenuation before it reaches the fluid interface, and hence, will produce a weak return signal that may be difficult to detect. To reduce energy loss in the transmitted signal, a waveguide or transmission line can be utilized to focus and guide the emitted signal. One such system is described in U.S. Pat. No. 3,832,900 to Ross (incorporated by reference) and utilizes an open coaxial line that is immersed in and filled by the contained fluids. A second such system is described in U.S. Pat. No. 5,610,611 (incorporated by reference). In these systems a guide wire or waveguide is positioned perpendicular to the surface of the liquid and extends therethrough to some reference level below the surface, typically the bottom of the tank. Reflections of the emitted signal, caused by the change in dielectric constant (the impedance contrast) at the interface of the fluids in the container, are propagated back along the wire or guide toward to a receiver. The time of flight, that is the time at which this reflection is received relative to the time of the transmitted or emitted pulse, is used to calculate the fluid or liquid level.

Even guided wave devices may present a weak “echo” or return signal if the dielectric constants across the fluid interface are similar, or if the interface is not well defined, such as due to foam present at the interface. Hence, there is therefore a need for a new level sensor which addresses the foregoing concern.

### SUMMARY OF THE INVENTION

The present invention is an improvement in a guided wave device comprising a reflective target system coupled to the waveguide. The target system includes a float and a reflector surface. The reflector surface can be integral with the float or a separate component fixed in a predetermined spatial relationship with the float.

### OBJECTS OF THE INVENTION

It is an object of the invention to provide a means for creating a strong reflection in a guided wave level measurement device.

It is an object of the invention to add a reflective target to a guided wave level measurement device.

It is an object of the invention to include a float with a reflector in a guided wave level measurement device.

It is an object of the invention to create a guide wave level measurement device incorporating both magnetostrictive and guided wave measurements.

### BRIEF DESCRIPTION OF THE DRAWINGS

FIG. 1 is a schematic of a prior art magnetostrictive level measurement device.

FIG. 2 is a schematic of a detail of the end of the magnetostrictive wire in the device of FIG. 1.

FIG. 3 is a schematic of a prior art guided wave radar level measurement device

FIG. 4 is a schematic of one embodiment of the improved guide wave level measurement device.

FIG. 5 is a schematic of the embodiment of FIG. 4 deployed in an external chamber.

FIG. 6A is a cross-section of one embodiment of the float and reflective surface used in the present invention.

FIG. 6B is a cross-section of a pancake style float with integral reflective surface.

FIG. 7 is a schematic showing one embodiment of the present invention coupled to an externally mounted sight glass.

FIG. 8 is a schematic showing one embodiment of the present invention coupled to an externally mounted magnetostrictive liquid measurement device.

### DESCRIPTION OF THE PREFERRED EMBODIMENT

The reflective target system is designed to work with a basic guided wave device. The basic guided wave device is shown in FIG. 3 disposed in a tank 5, although this system may also be deployed in an external chamber fluidly connected to the tank (not shown). The basic guided wave device includes a signal generator/emitter 1 and a signal receiver 2 (the emitter and receiver may be integrated into a single unit as depicted in FIG. 3) and a waveguide 3 operationally connected to the emitter 1 and receiver 2. The waveguide 3 may be a cable, or solid rod or of other suitable construction known in the art of various geometries. The guided wave device will either include or work in conjunction with a processor 4 to track and compare time of emission and time of reception (or accumulated time beginning at time of emission and ending at time of signal reception). The processor 4 may be located on the device or in a remote location. As shown in FIG. 3, the processor 4 is located on the measurement device but external to the tank or vessel 5. The guided wave device may also include electronic hardware or software to process or condition the outgoing signal and/or incoming reflection signal, such as to remove ghosts or false echoes or other artifacts, to shorten the outgoing signal length, etc. The basic guided wave devices are known in the art and will not be further described.

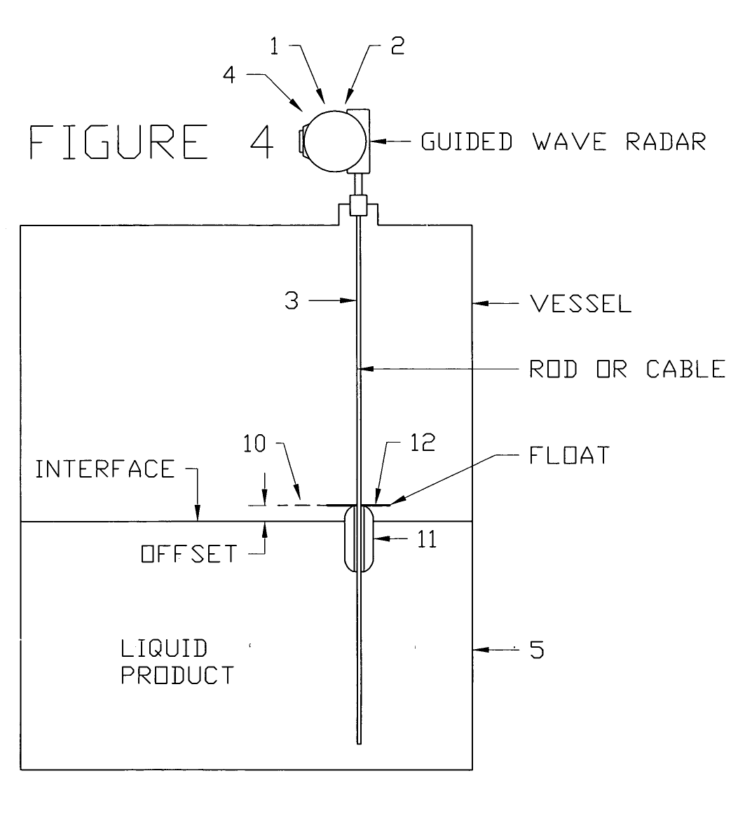

The improvement in the basic guided wave device is the addition of a target system 10, as shown in FIG. 4. The target system 10 includes a float 11 and a reflective surface 12. The float 11 is composed of a durable material with respect to the fluid materials in the tank 5 and is designed to “float” at the medium interface whose level is being monitored, such as an air/liquid interface. Materials such as plastics and metals, such as stainless steel, may be suitable. Float geometry generally is not relevant unless the reflective surface 12 is designed to be an integral aspect of the float 11, later described. The target system is displaceable with respect to the waveguide, such as being slidable about the waveguide, and follows the level of the fluid interface of interest.

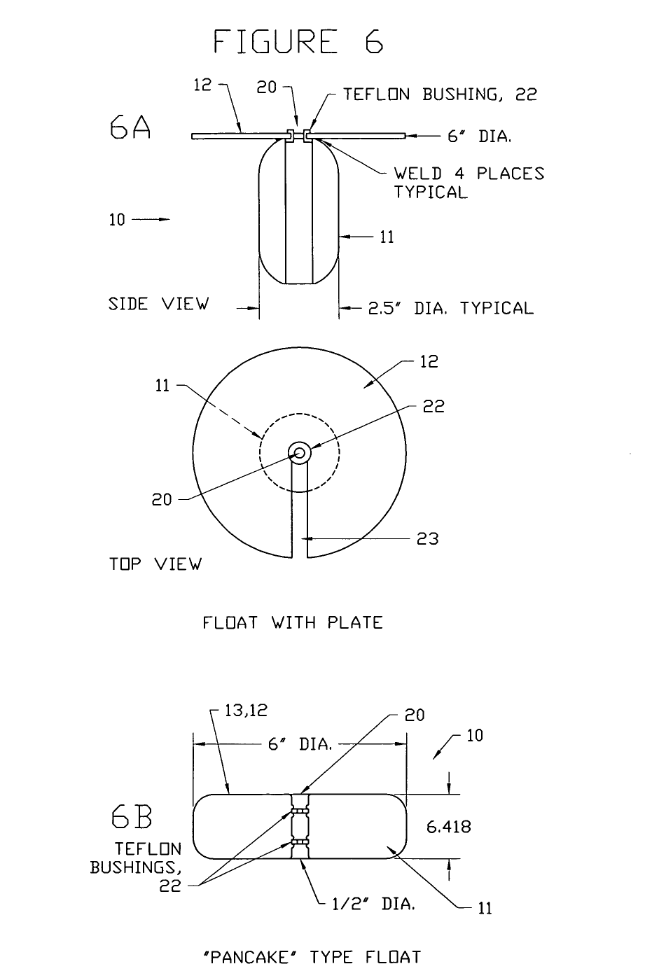

The target system's reflective surface 12 is designed to be present a surface of high impedance or dielectric contrast with respect to the fluid surrounding the reflective surface 12. In this fashion, a strong reflection will be generated at the reflective surface 12 by signals traveling on or guided by the waveguide 3. A stainless steel surface may be suitable for the reflective surface 12, as well as other metals or a metal coated surface. The reflective surface 12 may be an integrated part of the float 11, such as depicted in FIG. 6B, or a separate element form the float, as depicted in FIG. 6A.

A pancake style float 11 is shown in the cross-section in FIG. 6B. The pancake float 11 has a center opening 20 through which the waveguide 3 or guide wire passes, and the upper surface 13 of this pancake float 11 is flattened near the center opening 20. In this embodiment, the float 11 is either constructed of a suitable reflective material, such as metal, or the upper surface 13 near the center opening 20 is coated with a suitable material, to create a reflecting area or surface to interact with the emitted signal, such as a radar pulse. In some applications, the “float” body may be the reflective surface, provided the surface 11 itself is buoyant enough to float at the desired interface.

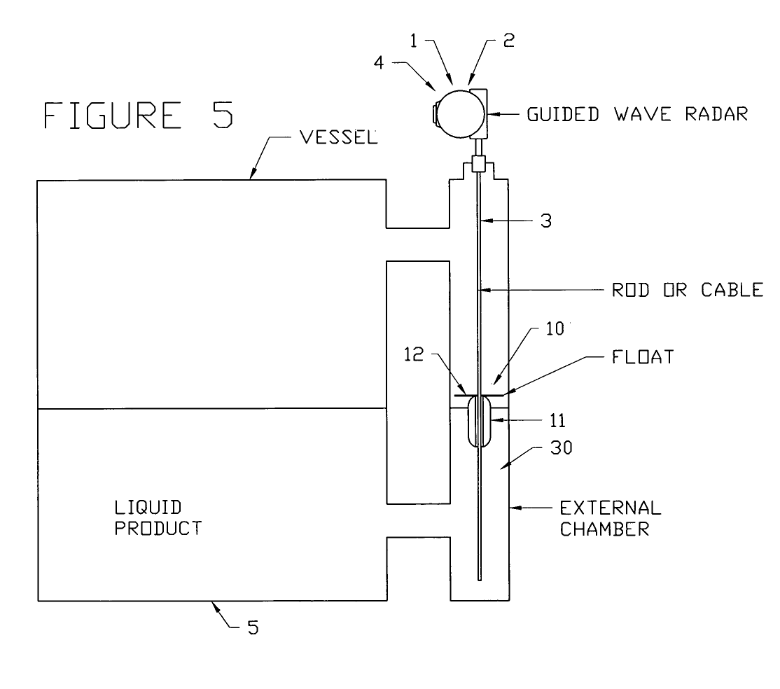

Another embodiment is shown in FIG. 6A, showing the reflective surface 12 mounted on the float 11, here shown mounted on the top of the float 11. The reflective surface 12 is a circular plate with a center opening 20 tack welded to a metal float. In either embodiment 6A or 6B, the reflective surface 12 is positioned in a predetermined relationship with respect to the float 11. As the float 11 moves in response to the location of the fluid interface, the reflective surface 12 moves in unison, as the target system is displaceable with respect to the waveguide. The exact location of the reflective surface 12 with respect to the desired interface will depend on the buoyancy of the target 10. In general, the reflective surface 12 will be positioned a distance above the interface of concern, as shown in FIGS. 4 and 5, but in operation, the location of the reflective surface 12 will be positioned a known or measurable distance from the interface.

A portion of the reflective surface 12 should be positioned adjacent to the waveguide 3 in order to “couple” a portion of the reflective surface 12 to a passing emitted signal. “Couple” is used in the sense of placing the reflective surface 11 in proximity to the waveguide 3 to allow the reflective surface 11 to interact with the signals traveling down the waveguide and create a reflected signal. For instance, the reflective surface 12 can be coupled to the waveguide 3 through the use of rings, loops or other mechanical devices 39 attached to the reflective surface or to the float, such as shown in FIG. 9. Alternatively, a separate guide wire could be used that is parallel to the waveguide and used as a guide for the float or reflective surface to the target, and hence operate to couple the reflective surface 12 to the waveguide 3. All such devices are considered a means to couple the reflective surface to the waveguide.

One means to couple the reflective surface 12 to the waveguide 3 is to use an annular shaped float such as the pancake float 11 shown in FIG. 6B, where the waveguide 3 passes through the center opening 20. The opening in the float 11 plate should be large enough to prevent the float/reflective surface from binding on the waveguide 3 as the target moves along the waveguide 3. To reduce the likelihood of binding, one or more bushings 22 of a slippery material, such as a plastic or teflon (polytetrafluoroethylene) composite material, may be inserted through the plate opening. As shown in FIG. 6A, the annular shaped reflecting surface 11 has a center opening 20 and a slot 23 leading to the center opening 20. A bushing is inserted during assembly through the slot to the center opening. As shown, the bushing 22 has a lower lip which locks into the float 11 upon assembly to prevent migration of the bushing 22.

The center opening cannot be too large, or the reflective surface 12 will decouple from emitted signals, and hence, not be “seen” by an emitted signal and generate no reflection or an insufficient reflection. The desired clearance between the reflective surface 11 and the waveguide 3 will depend on the characteristics of the emitted signal (frequency, amplitude, etc.). In the case of a radar signal, an opening 20 with clearance of as little as 1/8 inch about the waveguide can be sufficient.

In use, the target 10 must be calibrated, as the target reflective surface 12 is generally offset from the fluid interface level of interest. At least two different techniques can be used to calibrate the target system 10. One method is to observe the float/reflector placed in the fluid and to measure the vertical offset or relationship of the reflective surface 11 to the fluid interface. The user “calibrates” the system by accounting for the offset in the processing of the measured times or in the determination of start time (time of emission) or end time (time of receipt of the reflected signal), to produce an accurate measurement of the position fluid interface

Alternatively, a second method to “calibrate” the system is to operate the system at two different known fluid interface levels. The measured time of flight produced from these two known levels can be used to calculate the linear relationship between fluid interface level and measured time of flight and to program the processor accordingly. While a single measurement may be used (as the velocity of the signal is known), it is believed that using two or more measurements will provide a more robust calibration and allow the user to identify errors in the system.

It should be noted that there are two areas where the target system 10 provides ambiguous information on the interface level. The two areas are: (1) when the target system bottoms out and the float 11 is resting on the bottom of the tank 5; and (2) when the target 10 is topped out, as when the reflective surface 11 is resting against the top of the tank 5. In these instances, the position of the reflective surface 12 may not properly reflect the actual interface level. The system can be programmed to notify the user when an ambiguity is present in the readings.

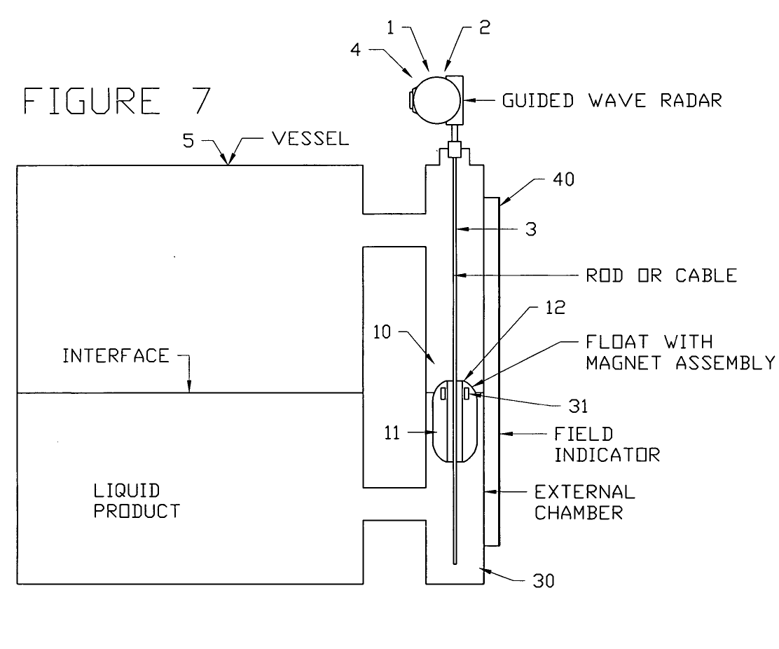

The improved targeted guided wave system can also be utilized in an external tube or chamber 30 that is fluidly connected to the tank 5, such as is shown in FIG. 5. The target system 10 also allows for incorporation of redundant measuring systems. For instance, as shown in FIG. 7, a wave guided target system device is shown located in an external chamber 30. The target 10 includes a float 11 that has one or more permanent magnets 31 associated with the float 11. The magnets 31 are preferably located in the float 11 in align with the fluid interface of interest. Adjacent to the external chamber 30 is a sight glass tube 40. Site glass tube 40 creates an interior hollow guide for a magnetically responsive material positioned within in the guide. The magnetically responsive material slides in the interior of the sight glass tube in response to the magnetic force created by the magnets 31. The site glass tube 40 has a view slot that allows a user to view the position of the magnetically responsive material in the site glass tube 40. Alternatively, the magnetically responsive material can act as an electrical bridge between two conductors placed within the site tube glass, and the location of the magnet produces a reading, such as resistance, that can be used to calculate the position of the material and hence the interface level.

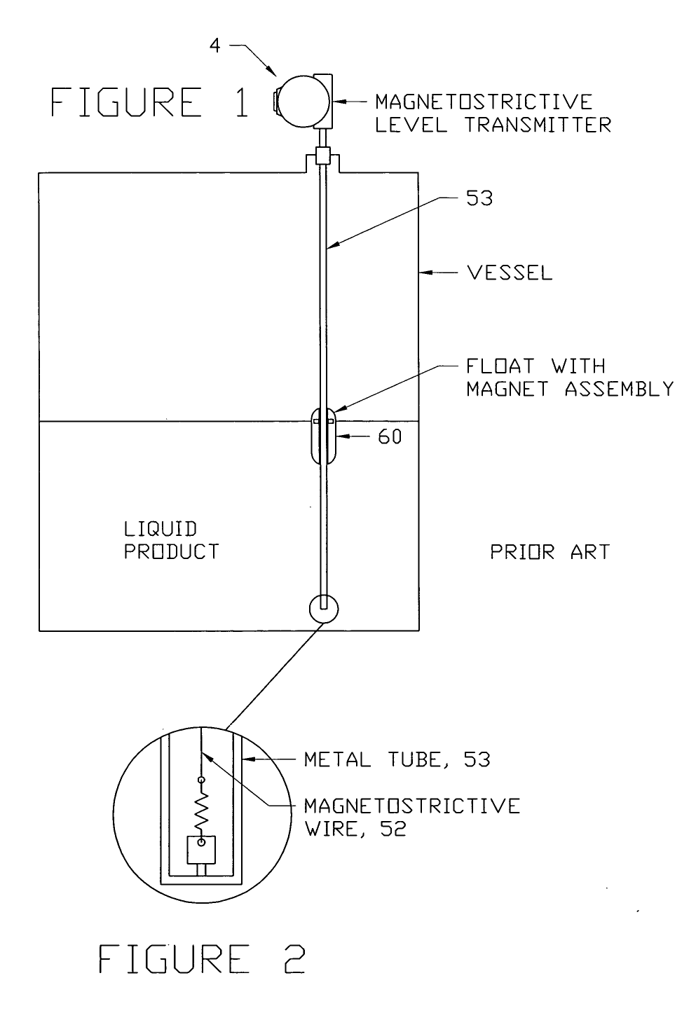

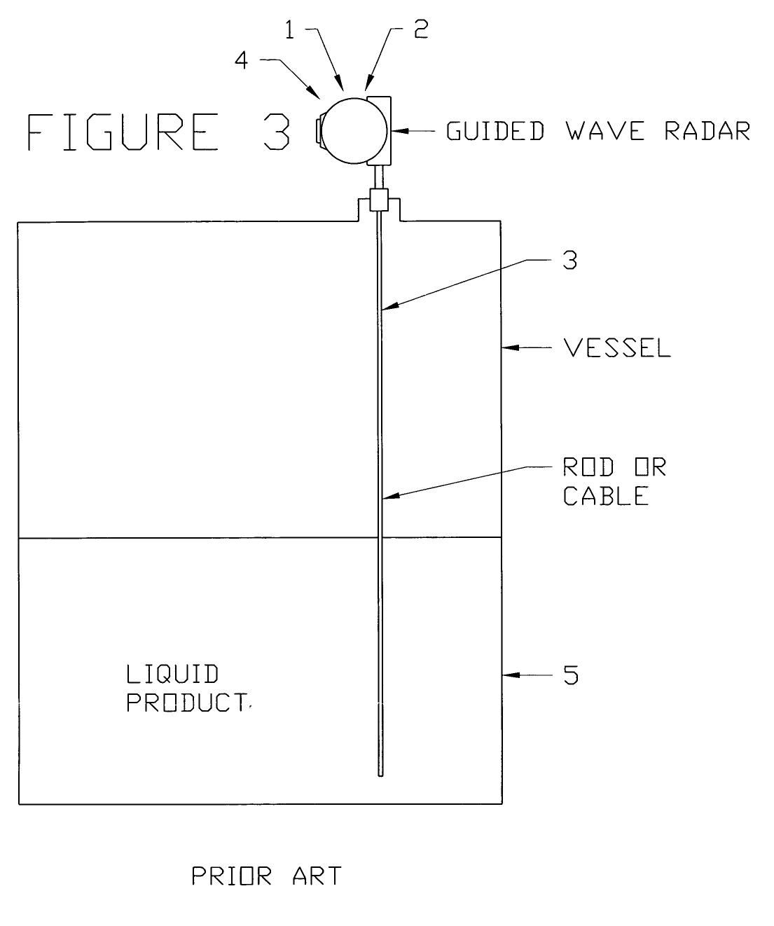

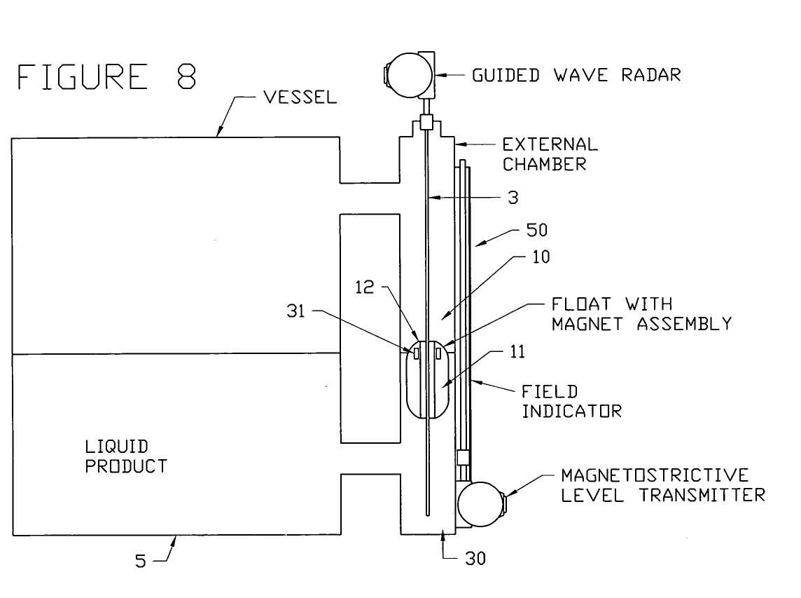

Alternatively, a targeted wave guided device that incorporates magnets 31 can be used in conjunction with a magnetostrictive measurement system 50. Magnetostrictive devices are well know in the art for linear distance or position measuring devices, for example, see U.S. Pat. No. 4,071,818 to Krisst; U.S. Pat. No. 4,144,559 to Chamuel; U.S. Pat. No. 4,238,844 to Ueda et al.; U.S. Pat. No. 3,423,673 to Bailey et al. and U.S. Pat. No. 3,898,555 to Tellerman, all incorporated by reference. A basic magnetostrictive device is shown in FIG. 1. Common to such devices are a magnetostrictive wire 52 which runs in a straight line through the tank, a means for inducing a torsional strain at a given position along the wire and a magnet which is displaceable along the wire, such as by incorporation into a float device 60, as shown in FIG. 1, where the wire 52 is positioned in the interior of a sensor tube 53. The position of the magnet represents the location of the interface and is determined as a function of the time required for a torsional disturbance to propagate from the area of the magnets to a detector located at the top of the sensing tube or wire. A targeted wage guided system incorporating magnets could be integrated with a magnetostrictive system, or magnetically coupled to a magnetostrictive system. For instance, U.S. Pat. No. 5,136,884 (incorporated by reference) shows a design with a probe (the actuator, magnetostrictive wire and detection electronics) adjacent to the tank to be level measured while the float, including permanent magnets, is positioned in an external chamber located adjacent to the magnetostrictive probe. A modification of this magnetostrictive design incorporating the targeted wave guided system is shown in FIG. 8. As shown, a magnetostrictive measurement system 50 (without a float) is located on the exterior of the external chamber 30 in which the targeted wave guided system is positioned. The float 11 utilized in the targeted guided wave system incorporates magnets 31. The magnets 31 are placed sufficiently close to the magnetostrictive measurement system 50 to work as with the magnetostrictive measurement system 50. Hence, the targeted guided wave measurement device can be incorporate features of other measurement systems to create a device measuring fluid levels with two distinct methods, such as one using magnetostrictive measurements, and another from the guided wave device.

Although the present invention has been described in terms of specific embodiments, it is anticipated that alterations and modifications thereof will no doubt become apparent to those skilled in the art which are intended to be included within the scope of the following claims.

1. An improved guided wave level measurement device comprising a waveguide, a signal generator and a signal receiver, the signal generator and signal receiver operationally connected to the waveguide, wherein the improvement comprises a target, said target displaceable with respect to said waveguide and coupled to said waveguide, said position of said target being detectable through time of flight measurements of a signal generated by said signal generator and reflected from said target.

2. The improved guided wave level measurement device according to claim 1 wherein said target includes a float and a reflective surface.

3. The improved guided wave level measurement device according to claim 2 wherein said reflective surface is integrated in said float.

4. The improved guided wave level measurement device according to claim 2 wherein said float includes a permanent magnet.

5. The improved guided wave level measurement device according to claim 4, further including a magnetostrictive measuring probe, said probe adapted to be magnetically coupled to said wave guided level measurement device by said magnets in said float.

6. The combination of a tank and a guided wave level measurement device comprising a waveguide, a signal generator and a signal receiver, the signal generator and signal receiver operationally connected to said waveguide, said waveguide positioned substantially vertically in the interior of said tank, and a target, said target displaceable with respect to said waveguide, said target including a reflective surface and having a means to couple said reflective surface to said waveguide in the interior of said tank.

7. The combination of a tank and guided wave measurement device of claim 6 wherein said tank has an external chamber fluidly connected to said tank, and said guided wave measurement device is located in said external chamber.

8. The combination of a tank and guided wave measurement device of claim 6 wherein said target further includes at least one permanent magnet, and a magnetostrictive probe positioned externally to said tank adjacent to said external chamber, said magnetostrictive probe being magnetically coupled to said permanent magnets.

9. The improved guided wave measurement device according to claim 1 wherein said reflective surface is a reflective plate.

10. The improved guided wave measurement device according to claim 9 wherein said reflective plate has an opening therethrough, said wave guide passing through said opening in said reflective plate.

11. A method of reflecting a generated signal from a fluid interface in a tank using a guided wave measurement system comprising the steps of:
a. generating a signal;
b. transmitting said signal on the waveguide of said guided wave measurement system;
c. reflecting said signal from a provided reflective surface, where said provided reflective surface is displaceable along said waveguide, and said reflective surface is positioned a predetermined distance from said fluid interface; and
d. detecting said reflected signal.
